(19) United States
(12) Patent Application Publication
(10) Pub. No.: US 2007/0237061 A1
(43) Pub. Date: Oct. 11, 2007

(54) Optical data storage medium

(75) Inventors: Zhi-Zhong Wang, Changhua County (TW); Han-Yi Chang, Taipei County (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/723,917

(22) Filed: Mar. 22, 2007

(30) Foreign Application Priority Data
Apr. 7, 2006 (TW) 095112303

(51) Int. Cl. G11B 7/24

(52) U.S. Cl. 369/275.1

(57) ABSTRACT

An optical data storage medium includes a first substrate, a first reflective layer, a second substrate, and a second reflective layer. In this case, the first substrate has a first surface and a second surface. The second surface is opposite to the first surface. The first surface has a structure fitting a BD (blue-ray) format. The first reflective layer is disposed on the first surface. The second substrate has a third surface and a fourth surface. The fourth surface is opposite to the third surface. The third surface faces the second surface. The third surface has a structure fitting an HD-DVD (high definition digital versatile disc) format. The second reflective layer is disposed on the third surface.

### BACKGROUND OF THE INVENTION

1. Field of Invention

The invention relates to an optical data storage medium and, in particular, to an optical data storage medium combing blue-ray disc (BD) format with high definition digital versatile disc (HD-DVD) format.

2. Related Art

Optical data storage media used to store data are the currently prevalent technology. With the aid of short wavelength blue laser technology and increasing demand for high storage capacity, optical data storage media with high storage capacity, e.g. the blue-ray disc (BD) and the high definition digital versatile disc (HD-DVD), have been developed. By recording at high density, it achieves greater storage capacity than that of the conventional compact disc (CD).

Different optical read/write systems have been developed, corresponding to different formats of optical data storage media. With reference to FIG. 1, the BD 10 is formed by bonding a 1.1 mm substrate 11 with a 0.1 mm cover layer 12 and is read/written using a blue laser beam passing through a lens 13 with 0.85 numerical aperture (NA). In addition, the HD-DVD 20 is formed by bonding two 0.6 mm substrates 21, 21′ and is read/written using the blue laser beam passing through a lens 22 with an NA of 0.65. Because the HD-DVD uses the same medium structure as DVD and uses a lens with the same NA as current DVD read/write system, the HD-DVD format is compatible with existing DVD optical read/write system.

It is desired to increase the storage capacity and enhance compatibility of the optical data storage medium. Therefore, it is an important subject of the invention to provide an optical data storage medium having enhanced compatibility with different optical read/write systems and higher storage capacity than that of existing media.

### SUMMARY OF THE INVENTION

In view of the foregoing, the invention is to provide an optical data storage medium with enhanced compatibility and high storage capacity.

To achieve the above objective, an optical data storage medium of the invention includes a first substrate, a first reflective layer, a second substrate, and a second reflective layer. In this case, the first substrate has a first surface and a second surface. The second surface is opposite to the first surface. The first surface has a structure fitting a BD (blue-ray disc) format. The first reflective layer is disposed on the first surface. The second substrate has a third surface and a fourth surface. The fourth surface is opposite to the third surface. The third surface faces the second surface. The third surface has a structure fitting an HD-DVD (high definition digital versatile disc) format. The second reflective layer is disposed on the third surface.

To achieve the above objective, an optical data storage medium of the invention includes a first substrate, a first reflective layer, a second reflective layer, and a second surface. In this case, the first substrate has a first surface and a second surface. The second surface is opposite to the first surface. The first surface has a structure fitting a BD (blue-ray disc) format. The second surface has a structure fitting an HD-DVD (high definition digital versatile disc) format. The first reflective layer is disposed on the first surface. The second reflective layer is disposed on the second surface. The second surface has a third surface and a fourth surface. The fourth surface is opposite to the third surface. The third surface faces the second surface.

To achieve the above objective, an optical data storage medium of the invention includes a first substrate and a second substrate. The first substrate has a structure fitting a BD (blue-ray) format. The second substrate has a structure fitting an HD-DVD (high definition digital versatile disc) format. The first substrate is bonded to the second substrate.

As mentioned above, the optical data storage medium according to the invention combines the structure fitting a BD format with the structure fitting an HD-DVD format into one single disc. In this case, the structure fitting the BD format and the structure fitting the HD-DVD format can be formed on different substrates, i.e. the first substrate and the second substrate, respectively. Moreover, both formats also can be formed on two opposite surfaces of one substrate. Therefore, the compatibility of the optical data storage medium is enhanced significantly by integrating two formats both read/written utilizing the blue laser. Consequently, the storage capacity of optical storage medium is also increased.

### BRIEF DESCRIPTION OF THE DRAWINGS

The invention will become more fully understood from the detailed description given herein below illustration only, and thus is not limitative of the present invention, and wherein:

FIG. 1 is a schematic view showing conventional read/write systems for a BD and an HD-DVD;

FIG. 2˜FIG 6 is a set of schematic views showing optical data storage media according to a preferred embodiment of the invention; and

FIG. 7˜FIG 11 is a set of schematic views showing optical data storage media according to another preferred embodiment of the invention.

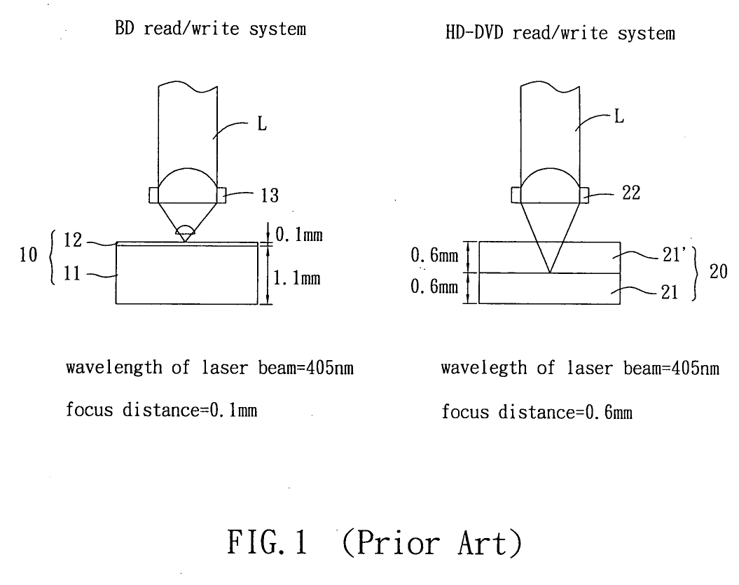

### DETAILED DESCRIPTION OF THE INVENTION

The present invention will be apparent from the following detailed description, which proceeds with reference to the accompanying drawings, wherein the same references relate to the same elements.

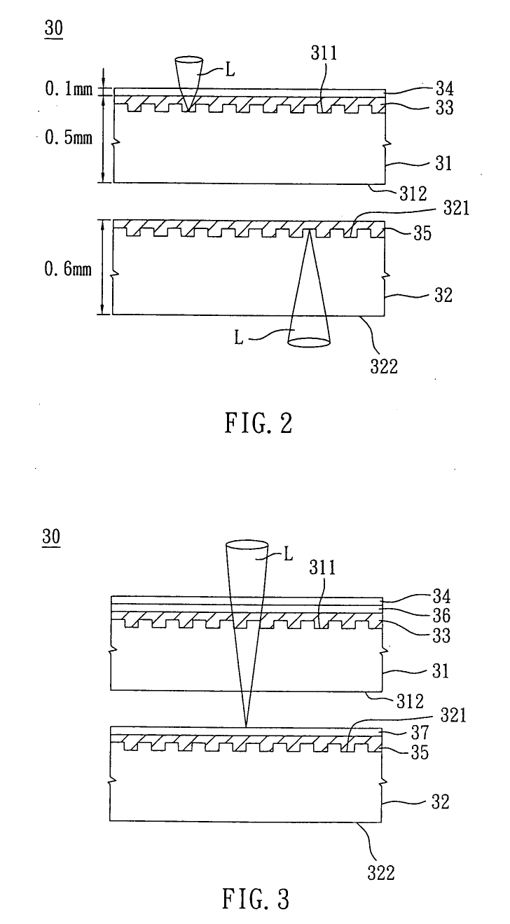

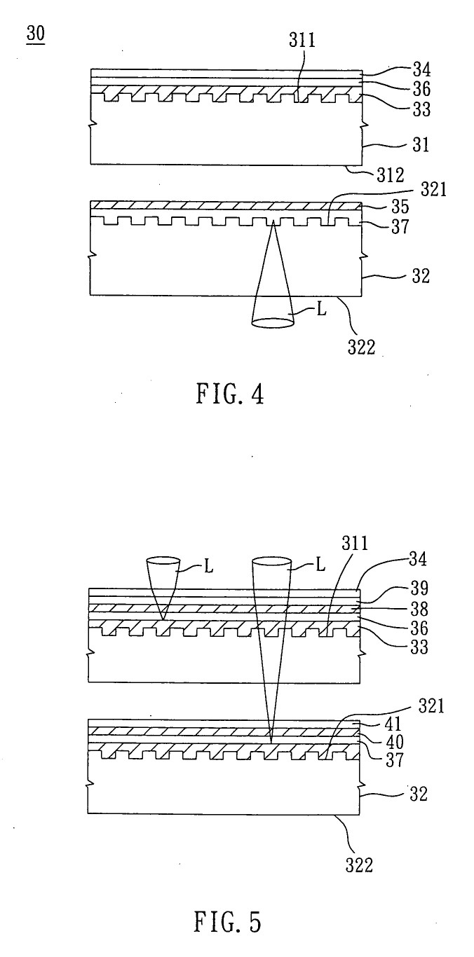

With reference to FIG. 2, an optical data storage medium 30 according to a preferred embodiment of the invention includes a first substrate 31 and a second substrate 32. The first substrate 31 has a first surface 311 and a second surface 312. The second surface 312 is opposite to the first surface 311. The second substrate 32 has a third surface 321 and a fourth surface 322. The fourth surface 322 is opposite to the third surface 321. The third surface 321 faces and adheres to the second surface 312 using an adhesive agent so that the first substrate 31 and the second substrate 32 are bonded. In this case, the adhesive agent can be a UV-cured gel.

The first surface 311 of the first substrate 31 has a structure fitting a blue-ray disc (BD) format. More particularly, the structure fitting the BD format can be formed in read-only, write-once, or rewritable BD format. For example, the structure fitting the BD format can be formed to have 0.32 μm track pitch by injection molding on the first surface 311. In the present embodiment, the thickness of the first substrate 31 is about 0.5 mm.

With reference to FIG. 2, taking the case in which the first surface 311 is a read-only BD format as an example, a first reflective layer 33 can be disposed on the first surface 311 by sputtering to reflect blue laser beam L effectively so that the data on the first surface 311 can be read. In addition, the optical data storage medium 30 further includes a protective layer 34, which is disposed over the first reflective layer 33 by spinning coating or lamination adhesion. In the present embodiment, the thickness of the protective layer 34 is about 0.1 mm.

The third surface 321 of the second substrate 32 has a structure fitting a high definition digital versatile disc (HD-DVD) format. Moreover, the structure fitting the HD-DVD can be formed in read-only, write-once, or rewritable HD-DVD format. For example, the structure fitting the HD-DVD can be formed to have 0.41 μm track pitch by injection molding on the third surface 321. In the present embodiment, thickness of the second substrate 32 is about 0.6 mm.

With reference to FIG. 2, taking the case in which the third surface 321 is a read-only HD-DVD format as an example, a second reflective layer 35 can be disposed on the third surface 321 by sputtering to effectively reflect blue laser beam L used to read data on the third surface 321.

With reference to FIG. 3 and FIG. 4, the optical data storage medium 30 further includes a first recording layer 36 disposed between the first reflective layer 33 and the protective layer 34 to be formed in BD-R or BD-RW format. In this case, the first surface 311 has the groove structure of BD format to address the blue laser beam L used to record data. In addition, the optical data storage medium 30 further includes a second recording layer 37. According to incident directions of the blue laser beam L, the second recording layer 37 can be disposed over the second reflective layer 35 (as shown in FIG. 3) or disposed between the third surface 321 of the second substrate 32 and the second reflective layer 35 (as shown in FIG. 4) to be formed in HD-DVD-R or HD-DVD-RW format. The groove structure of HD-DVD format is also formed on the third surface 321. In the present embodiment, the first recording layer 36 and the second recording layer 37 contains an organic dye or a phase change material. The organic dye, which degrades under laser beam irradiation, is used in the write-once optical data storage medium. The phase change material, which undergoes phase transitions under laser beam irradiation, is used in the rewritable optical data storage medium.

With reference to FIG. 5 and FIG. 6, the optical data storage medium 30 further includes a third reflective layer 38 and a third recording layer 39 that are disposed over the first recording layer 36 in sequence. Therefore, the storage capacity of the optical data storage medium 30 is raised by forming double recording layers. In this case, the third reflective layer 38 is semiopaque to allow partial of blue laser beam L to pass through the first recording layer 36 so that data can be read or wrote.

Moreover, the optical data storage medium 30 further includes a fourth reflective layer 40 and a fourth recording layer 41. In this case, the disposition order of the fourth reflective layer 40 and the fourth recording layer 41 is different depending on the incident directions of the blue laser beam L. As shown in FIG. 5, the fourth reflective layer 40 and the fourth recording layer 41 are disposed over the second recording layer 37 in order. Therefore, the fourth reflective layer 40 is semiopaque. Additionally, as shown in FIG. 6, the fourth recording layer 41 and the fourth reflective layer 40 are disposed over the second reflective layer 35 of the optical data storage medium 30 showing in FIG. 4 in ascending order. However, the optical data storage medium 30 of the invention is not limited to having double recording layers as mentioned above. For raising storage capacity, it is possible to include multiple recording layers in the optical data storage medium 30. In this case, material of the third recording layer 39 and the fourth recording layer 41 can contain the organic dye or phase change material.

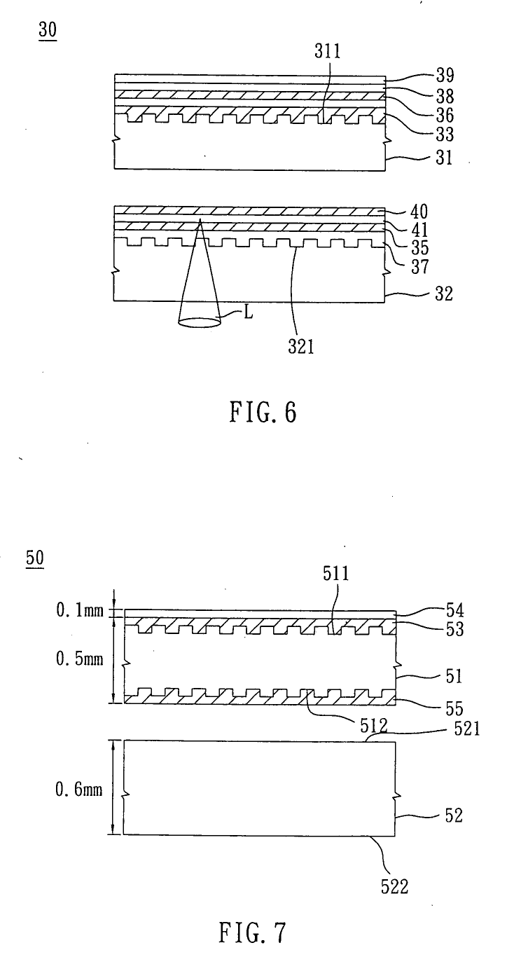

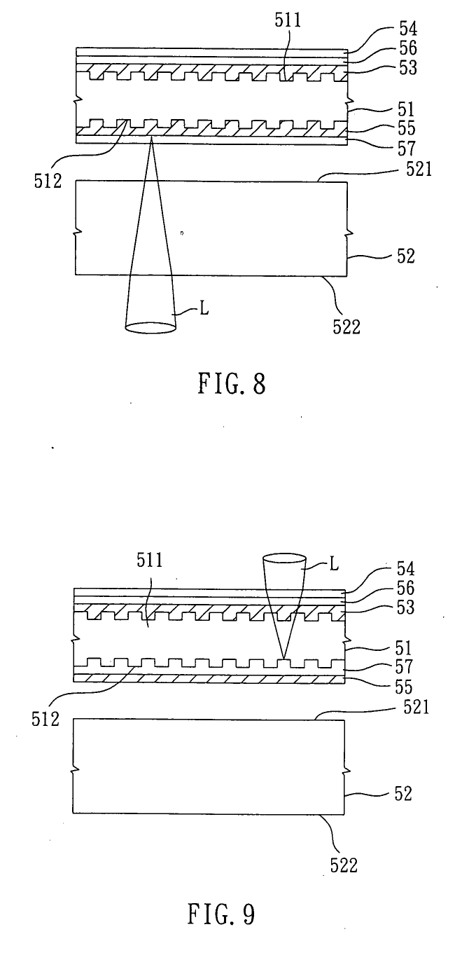

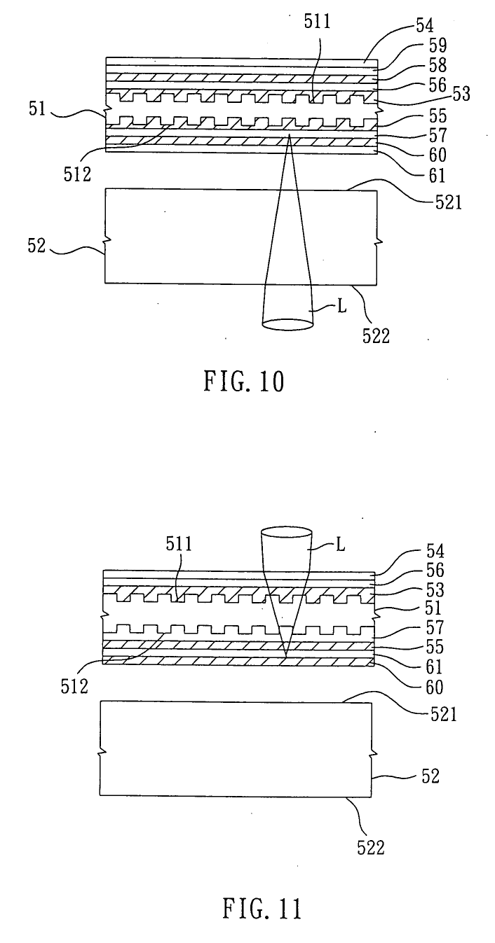

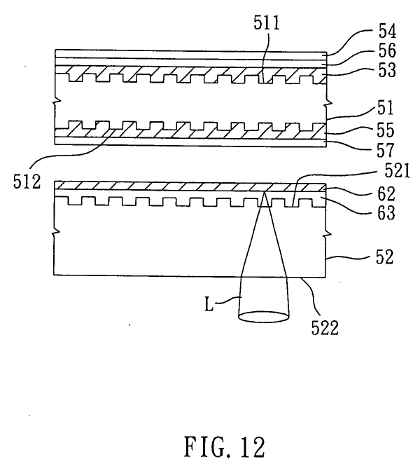

With reference to FIG. 7, an optical data storage medium 50 according to another preferred embodiment of the invention includes a first substrate 51 and a second substrate 52. The first substrate 51 has a first surface 511 and a second surface 512 that are disposed in opposition to each other. The second substrate 52 has a third surface 521 and a fourth surface 522 that are disposed in opposition to each other. The third surface 521 of the second substrate 52 faces and adheres to the second surface 512 of the first substrate 51.

In the present embodiment, because the thickness and the method of bonding of the first substrate 51 and the second substrate 52, the structure fitting the BD format on the first surface 511 and the way of disposition, the method of formation and significant functions of a first reflective layer 53 and a protective layer 54 is the same as the same elements mentioned above, the description is omitted for concision.

In the present embodiment, as shown in FIG. 7, the second surface 512 of the first substrate 51 has a structure fitting an HD-DVD format and a second reflective layer 55 is disposed on the second surface 512. However, because the structure of the HD-DVD, the method of formation and significant functions of the second reflective layer 55 in the present embodiment are the same as those mentioned above, the description is also omitted for concision. Taking the case that the first surface 511 and the second surface 512 are in read-only BD format and in read-only HD-DVD format respectively as example, the structure of having pits on the opposite sides of the first substrate 51 for recording data can be formed by injection molding and utilizing a double-sided stamper. After that, the first reflective layer 53 and the second reflective layer 55 are disposed on the first surface 53 and the second surface 55 respectively by sputtering.

Additionally, with reference to FIG. 8 and FIG. 9, the optical data storage medium 50 further includes a first recording layer 56 disposed over the first reflective layer 53. Moreover, the optical data storage medium 50 also can include a second recording layer 57. According to the incident directions of blue laser beam L, the second recording layer 57 can be disposed over the second reflective layer 55 (as shown in FIG. 8) or between the first substrate 51 and the second reflective layer 55 (as shown in FIG. 9).

With reference to FIG. 10 and FIG. 11, the optical data storage medium 50 further includes a third reflective layer 58 and a third recording layer 59, disposed over the first recording layer 56 in sequence so that the optical data storage medium having double recording layers is formed. Moreover, the optical information medium 50 also can further include a fourth reflective layer 60 and a fourth recording layer 61. As mentioned above, according to the incident directions of blue laser beam L, the fourth reflective layer 60 and the fourth recording layer 61 can be disposed over the second recording layer 57 in sequence. In this case, the fourth reflective layer 60 is semiopaque to allow partial passage of blue laser beam L. In addition, as shown in FIG. 11, the order of the fourth recording layer 61 and the fourth reflective layer 60 also can be followed to be disposed over the second reflective layer 55. In this case, the second reflective layer 55 is semiopaque.

With reference to FIG. 12, the optical data storage medium 50 also can have a structure fitting the HD-DVD format on the third surface 521 of the second substrate 52. Moreover, a fifth reflective layer 62 is disposed over the third surface 521. Therefore, the storage capacity is increased significantly by way of forming the HD-DVD structures on the second surface 512 and the third surface 521. As mentioned above, the structure fitting HD-DVD format can be formed in read-only, write-once, or rewritable HD-DVD format. For write-once HD-DVD format and rewritable HD-DVD format, a fifth recording layer 63 is disposed over the third surface 521. The fifth recording layer 63 can be disposed between the fifth reflective layer 62 and the second substrate 52 (as shown in FIG. 12) or over the fifth reflective layer 62 depending on the incident directions of blue laser beam L.

In the present embodiment, because the material and function of these recording layers 56, 57, 59, 61 and 63 are the same as the same elements mentioned above, the description is omitted.

In conclusion, the optical data storage medium according to the invention combines the structure fitting a BD format with the structure fitting an HD-DVD into one single disc. In this case, the structure fitting the BD format and the structure fitting the HD-DVD can be formed on different substrates, i.e. the first substrate and the second substrate, respectively. Moreover, both formats also can be formed on two opposite surfaces of one substrate. Therefore, the compatibility of the optical data storage medium is enhanced effectively by integrating two formats both read/written utilizing blue laser. Consequently, the storage capacity of optical storage medium is also increased.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical data storage medium, comprising:
a first substrate, which has a first surface and a second surface opposite to the first surface, wherein the first surface has a structure fitting a BD (blue-ray disc) format;
a first reflective layer, which is disposed on the first surface;
a second substrate, which has a third surface and a fourth surface opposite to the third surface, wherein the third surface faces the second surface, and the third surface has a structure fitting an HD-DVD (high definition digital versatile disc) format; and
a second reflective layer, which is disposed on the third surface.

2. The optical data storage medium of claim 1, further comprising:
a first recording layer, which is disposed over the first reflective layer.

3. The optical data storage medium of claim 1, further comprising:
a second recording layer, which is disposed over the second reflective layer.

4. The optical data storage medium of claim 1, further comprising:
a second recording layer, which is disposed between the second substrate and the second reflective layer.

5. The optical data storage medium of claim 1, further comprising:
a protective layer, which is disposed over the first reflective layer.

6. The optical data storage medium of claim 5, wherein the thickness of the protective layer is about 0.1 mm.

7. The optical data storage medium of claim 1, wherein the thickness of the first substrate is about 0.5 mm.

8. The optical data storage medium of claim 1, wherein the thickness of the second substrate is about 0.6 mm.

9. An optical data storage medium, comprising:
a first substrate, which has a first surface and a second surface opposite to the first surface, wherein the first surface has a structure fitting a BD (blue-ray disc) format, and the second surface has a structure fitting an HD-DVD (high definition digital versatile disc) format;
a first reflective layer, which is disposed on the first surface;
a second reflective layer, which is disposed on the second surface; and
a second surface, which has a third surface and a fourth surface opposite to the third surface, wherein the third surface faces the second surface.

10. The optical data storage medium of claim 9, further comprising:
a first recording layer, which is disposed over the first reflective layer.

11. The optical data storage medium of claim 9, further comprising:
a second recording layer, which is disposed over the second reflective layer.

12. The optical data storage medium of claim 9, further comprising:
a second recording layer, which is disposed between the first substrate and the second reflective layer.

13. The optical data storage medium of claim 9, further comprising:
a protective layer, which is disposed over the first reflective layer.

14. The optical data storage medium of claim 13, wherein the thickness of the protective layer is about 0.1 mm.

15. The optical data storage medium of claim 9, wherein the thickness of the first substrate is about 0.5 mm.

16. The optical data storage medium of claim 9, wherein the thickness of the second substrate is about 0.6 mm.

17. The optical data storage medium of claim 9, wherein the third surface has a structure fitting the HD-DVD format.

18. An optical data storage medium, comprising:
a first substrate, which has a structure fitting a BD (blue-ray disc) format; and
a second substrate, which has a structure of an HD-DVD (high definition digital versatile disc) format, wherein the first substrate is bonded to the second substrate.
